(19) United States
(12) Patent Application Publication
(10) Pub. No.: US 2009/0263173 A1
(43) Pub. Date: Oct. 22, 2009

(54) METHODS AND SYSTEMS FOR GENERATING DYNAMIC ORDER DOCUMENTS

(75) Inventors: John D. Kenney, Beverly, MA (US); Michael C. Jones, Huntington Beach, CA (US); Kenneth S. Bland, JR., Honolulu, HI (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 12/105,491

(22) Filed: Apr. 18, 2008

(51) Int. Cl. B41J 5/30

(52) U.S. Cl. 400/61

(57) ABSTRACT

In an embodiment, a system for generating a document may include a configuration/pricing module configured to receive input data, a document rendering module configured to generate a worksheet based on at least a portion of the input data and a composition module. The composition module may be configured to generate one or more dynamic tables having a plurality of fields, where each field of each dynamic table is automatically populated with a non-null value based on relevant information from the worksheet. The composition module may also be configured to identify one or more relevant terms and conditions provisions based on the relevant information, and automatically populate at least a portion of a document with the one or more dynamic tables and the relevant terms and conditions provisions.

### BACKGROUND

Various types of forms, such as purchase orders, order agreements, contracts and the like, can be used to document commercial transactions. Because such forms are prevalent, producing forms automatically can significantly ease transaction costs. Methods and systems for automated document production and automatic document layout are known in the art, and described in, for example, U.S. Pat. No. 7,024,022 to Harrington et al.

Conventionally, order transactions are documented with standard forms that include irrelevant information and/or non-utilized conditions and options. Standardized forms usually include inapplicable information such as empty data fields, empty check boxes for options that are not selected and/or terms and conditions that do not correspond to the transaction. For example, a form that is produced documenting a customer's purchase of a product often includes information that would only be pertinent if the customer were leasing the product. In addition, a form that is produced to document a customer's purchase of a single item often includes fields for additional items that remain empty. Similarly, a set of terms and conditions are typically included that provide references indicating which provisions are applicable for the present transaction. As such, a customer must review substantial information that is irrelevant to the transaction. Moreover, the pertinent information for the transaction can be difficult to locate. Accordingly, standardized forms used for commercial transactions are often difficult for a customer to understand.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to a “document” is a reference to one or more documents and equivalents thereof known to those skilled in the art, and so forth. Unless defined otherwise, all technical and scientific terms used herein have the same meanings as commonly understood by one or ordinary skill in the art. As used herein, the term “comprising” means “including, but not limited to.”

In an embodiment, a system for generating a document may include a configuration/pricing module configured to receive input data, a document rendering module configured to generate a worksheet based on at least a portion of the input data and a composition module. The composition module may be configured to generate one or more dynamic tables having a plurality of fields, where each field of each dynamic table is automatically populated with a non-null value based on relevant information from the worksheet. The composition module may also be configured to identify one or more relevant terms and conditions provisions based on the relevant information, and automatically populate at least a portion of a document with the one or more dynamic tables and the relevant terms and conditions provisions.

In an embodiment, a method of automatically generating a document may include receiving input data pertaining to a transaction, where the input data identifies one or more of a product and a service, and generating one or more dynamic tables having a plurality of fields, where each field of each dynamic table is populated with a non-null value from the input data. The method may also include identifying one or more terms and conditions provisions relevant to the input data, automatically populating a dynamic portion of a document with only the one or more dynamic tables and the one or more identified terms and conditions provisions and providing the document to a user.

In an embodiment, a method of generating a contract may include presenting a user with an input form, receiving, via the input form, information relevant to a transaction, generating a worksheet comprising a plurality of transaction fields and data corresponding to one or more of the transaction fields and selecting, from the worksheet, at least one transaction field. Each selected transaction field may correspond to received information having a non-null value. The method may also include identifying one or more relevant terms and conditions provisions for the transaction based on the information and generating a contract having at least one selected transaction field and the one or more identified terms and conditions provisions.

### DESCRIPTION OF THE DRAWINGS

Aspects, features, benefits and advantages of the present invention will be apparent with regard to the following description and accompanying drawings, of which:

FIG. 1 illustrates an exemplary method of generating a document according to an embodiment.

FIG. 2 depicts an exemplary portion of a worksheet according to an embodiment.

FIG. 3 illustrates an exemplary dynamic table according to an embodiment.

FIG. 4 illustrates an exemplary multipurpose column according to an embodiment.

FIG. 5 illustrates an exemplary document according to an embodiment.

FIG. 6 illustrates an exemplary system for generating a document according to an embodiment.

### DETAILED DESCRIPTION

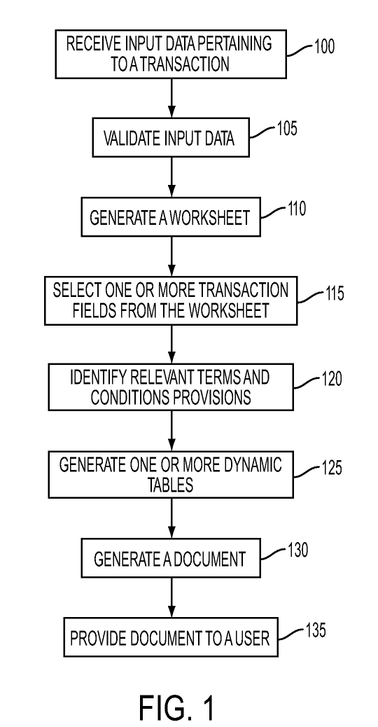

FIG. 1 illustrates an exemplary method of generating a document according to an embodiment. As shown in FIG. 1, input data pertaining to a transaction may be received 100. In an embodiment, the input data may be received 100 from a user via an electronic input form. For example, a user may enter certain information regarding a transaction, such as a customer's name, billing address, telephone number and/or the like. In an embodiment, the user may select information from one or more menus, dropdown lists, checkboxes and/or the like. In an embodiment, the input data may identify a product or service that is the subject of the transaction. For example, if a customer purchases a piece of equipment, such as a copy machine, the input data may include a corresponding purchase price, a model number, a shipping address and/or the like.

In an embodiment, input data may be received 100 from previous transaction records. For example, if a customer is a returning customer, certain information, such as the customer's name, address, telephone number and the like that was received during the prior transaction may be used during the current transaction. In an embodiment, input data may be received 100 from one or more hard copy records. For example, a customer may provide information via a handwritten or typed form, and the information may be received 100 by scanning the document, uploading the document or the like.

In an embodiment, the input data may be validated 105. At least a portion of the input data may be checked for compliance with one or more predefined conditions. For example, a portion of input data may be validated to ensure that each item that is being leased has a corresponding maintenance option. In an embodiment, at least a portion of the input data may be compared with a range of expected values. For example, input data corresponding to a purchase price of a product may be compared with a range of prices associated with the product to ensure that the purchase price is not below a certain threshold. In an embodiment, validation may include determining whether a credit check has been performed.

In an embodiment, the validation 105 may include alerting a user that one or more validations failed. For example, if a portion of the input data is invalid, a user may be alerted. The user may then be asked to re-enter or correct the invalid portion of the input data.

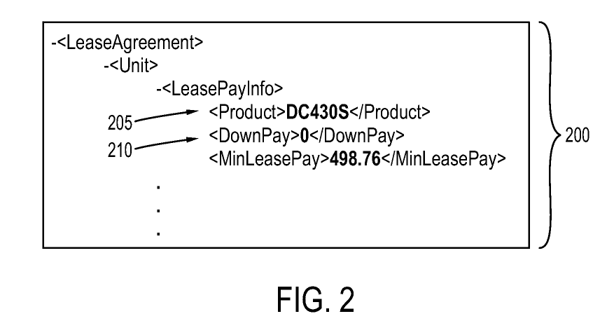

In an embodiment, a worksheet may be generated 110 based on at least a portion of the input data. The worksheet may include a plurality of transaction fields and each transaction field may have one or more elements of corresponding data. In an embodiment, the worksheet may be an XML file or the like. FIG. 2 illustrates a portion of an exemplary worksheet according to an embodiment. The worksheet 200 may be populated with at least a portion of the received input data. For example, if the input data specifies a product, a corresponding transaction field 205 may be populated with a model number associated with the product. As illustrated by FIG. 2, it is possible for the worksheet to have one or more transaction fields that do not have corresponding data. For example, if a customer is not making a down payment, a transaction field 210 corresponding to a down payment amount may have a null data value, such as ‘0.’

Referring back to FIG. 1, in an embodiment, one or more transaction fields may be selected 115 from the worksheet. Each selected transaction field may correspond to data having a non-null value. If a user entered information or data for the field, the data for that field may have a non-null value. Otherwise, it may have a null value. For example, if a customer purchases a piece of equipment, any transaction field associated with leasing the equipment, such as monthly payment, purchase option and/or the like, may not be selected. This may be because the transaction fields associated with leasing the equipment are not applicable to the purchase transaction and therefore may have null values associated with them.

In an embodiment, one or more relevant terms and conditions provisions for the transaction may be identified 120. The terms and conditions provisions may define the terms and conditions that govern the transaction. For example, if a customer leases a piece of equipment, such as a copier machine, exemplary terms and conditions provisions may include one or more warranties associated with the copier machine, terms associated with maintenance and/or service of the copier machine, payment terms, terms and conditions governing trade-in equipment and the like.

In an embodiment, a terms and conditions provision may be identified 120 based on one or more predefined logical conditions. In an embodiment, one or more logical conditions may be based on one or more of a customer type, an order type, a product, a service plan or the like. In an embodiment, a customer type may indicate whether a customer is a new customer, a returning customer, a federal government, a state government, a local government and/or the like. In an embodiment, an order type may indicate whether an order is a lease, a rental, a purchase, maintenance only or the like. In an embodiment, products may include equipment, accessories, hardware, software or the like. In an embodiment, a service plan may identify whether consumable supplies are included in the transaction, whether pricing is fixed, whether the service plan includes extended service coverage and/or the like.

In an embodiment, only the terms and conditions provisions that are relevant to the transaction and/or the input data may be identified 120. For example, if a transaction does not include a trade-in, the terms and conditions associated with trade-in equipment may not be identified 120. In an embodiment, a transaction may include a plurality of products that require different terms and conditions provisions. For example, one product that is the subject of a transaction may have supplies included in a service plan, while a second product that is the subject of the same transaction may not. As such, a terms and conditions provision may be identified 120 when it is required by any of the products in a transaction. Similarly, particular terms and conditions provisions may only be identified 120 when certain predefined conditions are met. For example, a refinancing disclosure may only be identified 120 when it is required by law to be included in the document.

In an embodiment, a document may be generated based on at least a portion of the input data, a portion of the information from the worksheet and/or the like. The document may be a contract, a purchase proposal, an order agreement, a trade-in tag, an order-submission cover sheet or the like. In an embodiment, one or more dynamic tables may be generated 125 based on the input data. Each dynamic table may include a plurality of fields and each field may be populated with a non-null value.

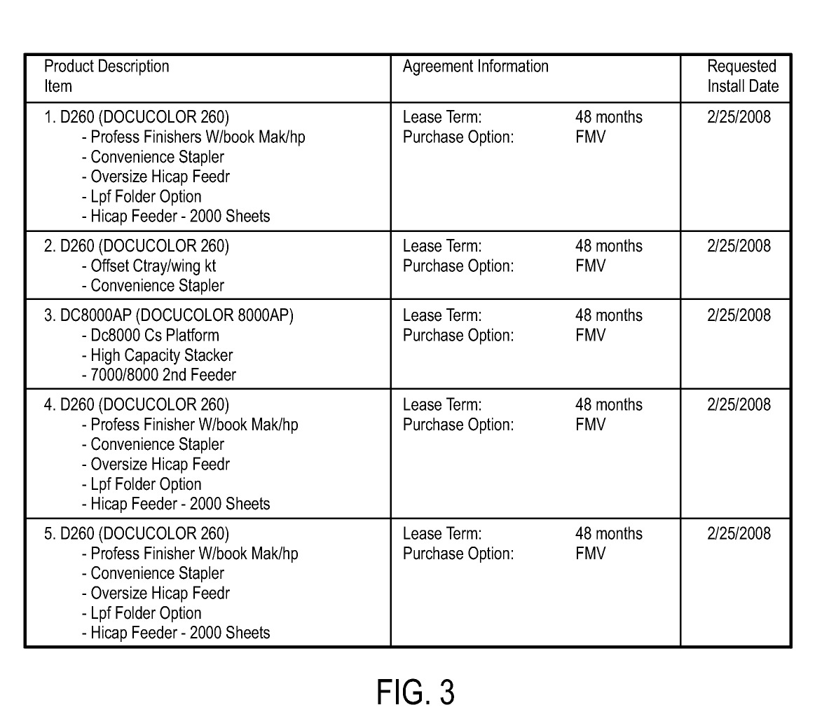

FIG. 3 illustrates an exemplary dynamic table that may be included in a purchase proposal according to an embodiment. However, as illustrated, only the transaction fields having non-null values are included in the dynamic table. For example, a worksheet may include transaction fields for products that are not subject to the current transaction. Instead of including inapplicable information, only transaction fields having non-null values may be used to generate a dynamic table. As such, the dynamic table may only include information that is relevant to the transaction.

In an embodiment, the selected transaction fields may be arranged in an appropriate sequence in a dynamic table. In an embodiment, a sequence may be pre-determined based on one or more of a transaction type, a customer type, a portion of the input data, a billing address, a shipping address or the like.

In an embodiment, a dynamic table may be dynamically formatted. For example, the size of a dynamic table may be determined based on the amount of space required to display the selected transaction fields. For example, if a transaction does not include a trade-in, then a “trade-in” column may not be generated and the columns in the dynamic table may be expanded to compensate. Conversely, if a transaction does include a trade-in, a “trade-in” column may be included in the dynamic table and the existing columns may be compressed to adequately display the trade-in information.

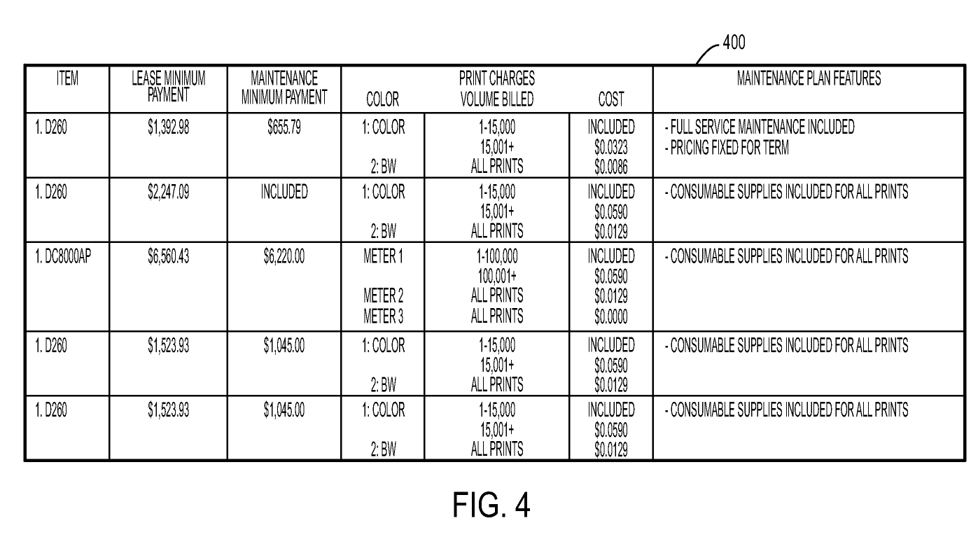

In an embodiment, one or more multi-purpose columns may be included in the dynamic table. A multi-purpose column may include input data that corresponds to a plurality of different transaction fields from the worksheet. For example, FIG. 4 illustrates an exemplary multipurpose column 400 that includes information regarding maintenance plan features.

Referring back to FIG. 1, a document may be generated 130. In an embodiment, a dynamic portion of a document may be automatically populated with one or more dynamic tables. A dynamic portion of a document may or may not be contiguous. As such, a document may include static information, such as a header, a logo, contact information and/or the like along with one or more dynamic tables. In an embodiment, a dynamic portion of a document may be automatically populated with one or more identified terms and conditions provisions.

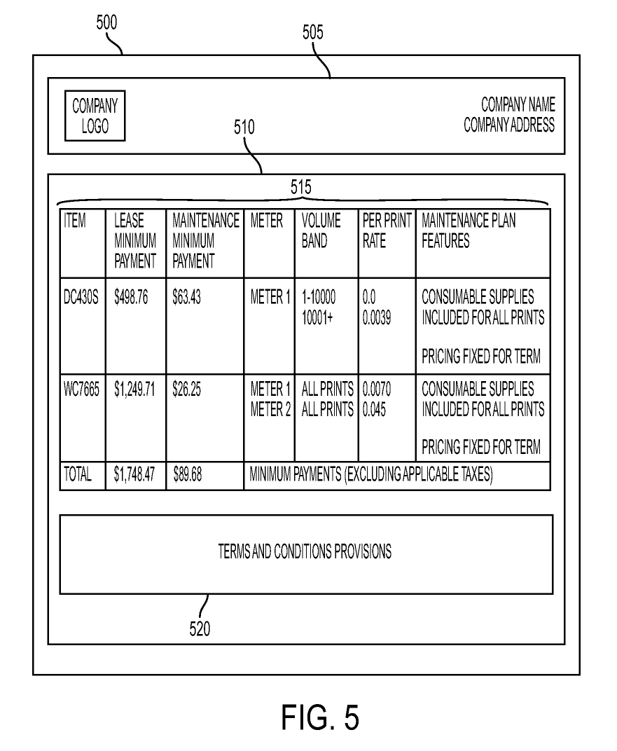

FIG. 5 illustrates an exemplary document that may be generated using at least the worksheet portion depicted in FIG. 2 according to an embodiment. The document 500 includes static information, such as a company header 505 and a dynamic portion 510. As illustrated in FIG. 5, the dynamic portion 510 may include a dynamic table 515 and a set of terms and conditions provisions 520 relevant to the transaction. In an embodiment, the document may have a particular file format, such as PDF or the like.

In an embodiment, the document's format may be based on the document type. For example, if a document is an order agreement, the document may include a signature block. However, if a document is a purchase proposal, the document may not include a signature block.

In an embodiment, the generated document may be provided 135 to a user. The document may be printed, taxed to a user and/or emailed to a user. In addition, a hyperlink to the document may be provided to a user. In an embodiment, a copy of the document may be sent to a document repository for storage.

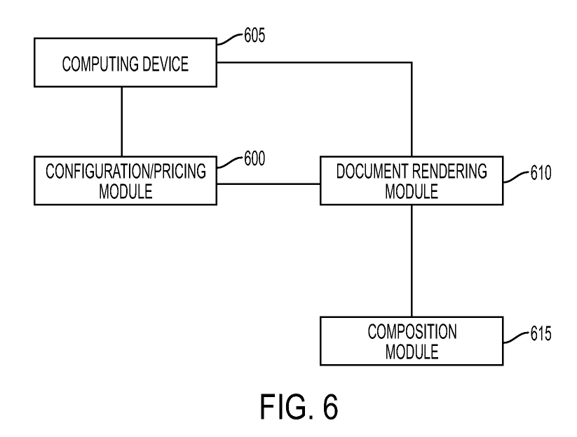

FIG. 6 depicts a system for generating a document according to an embodiment. The system may include one or more of a configuration/pricing module 600, a document rendering module 610 and a composition module 615. Each module may be a software module or a hardware module. In addition, each module may be self-contained component that may interact with the document generating system.

In an embodiment, a configuration/pricing module 600 may be configured to receive and validate input data from a user via a computing device 605. A document rendering module 610 may be configured to receive at least a portion of the input data from the configuration/pricing module 600. The document rendering module 610 may also be configured to generate a worksheet based on the received input data and to select one or more transaction fields having non-null values from the worksheet. A composition module 615 may be configured to generate one or more dynamic tables and to generate a document having one or more of the dynamic tables and one or more relevant terms and conditions provisions. The composition module 615 may be configured to transmit the generated document to the document rendering module 610. In an embodiment, the document rendering module 610 may be configured to transmit the document to the user's computing device 605.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for generating a document, the system comprising:
a configuration/pricing module configured to receive input data;
a document rendering module configured to generate a worksheet based on at least a portion of the input data; and
a composition module configured to:
generate one or more dynamic tables having a plurality of fields, wherein each field of each dynamic table is automatically populated with a non-null value based on relevant information from the worksheet,
identify one or more relevant terms and conditions provisions based on the relevant information, and
automatically populate at least a portion of a document with the one or more dynamic tables and the relevant terms and conditions provisions.

2. The system of claim 1, wherein the configuration pricing module is configured to validate the input data and alert the user if any portion of the input data is invalid.

3. The system of claim 1, wherein the composition module is configured to identify a terms and conditions provision based on one or more of the following:
a customer type;
an order type;
a product; and
a service plan.

4. The system of claim 1, wherein the generation of a dynamic table comprises selecting a worksheets selecting one or more fields that are non-null from the worksheet, and arranging the selected fields into a sequence.

5. The system of claim 5, wherein the composition module is configured to group the selected fields based on one of a bill-to location and a ship-to location.

6. The system of claim 1, wherein the composition module is configured to automatically populate one or more dynamic portions of one or more of:
a purchase proposal;
an order agreement;
a trade-in tag; and
an order-submission cover sheet.

7. The system of claim 1, wherein the composition module is configured to transmit the document to the document rendering module, wherein the document rendering module is configured to perform one or more of the following:
transmit the document to a computing device;
fax the document to a user;
email the document to the user; and
provide the user with a hyperlink to the document.

8. The system of claim 1, wherein the document generation module is configured to send the document to a document repository.

9. A method of automatically generating a document, the method comprising:
receiving input data pertaining to a transaction, wherein the input data identifies one or more of a product and a service;
generating one or more dynamic tables having a plurality of fields, wherein each field of each dynamic table is populated with a non-null value from the input data;
identifying one or more terms and conditions provisions relevant to the input data;
automatically populating a dynamic portion of a document with only the one or more dynamic tables and the one or more identified terms and conditions provisions; and
providing the document to a user.

10. The method of claim 9, further comprising:
validating the input data; and
alerting the user if any portion of the input data is invalid.

11. The method of claim 9, wherein identifying one or more terms and conditions provisions comprises:
identifying a terms and conditions provision based on one or more of the following:
a customer type,
an order type,
a product, and
a service plan.

12. The method of claim 9, wherein generating one or more dynamic tables comprises:
selecting a worksheet;
selecting one or more fields that are non-null from the worksheet; and
arranging the one or more selected fields into a sequence.

13. The method of claim 12, wherein arranging the one or more selected fields comprises:
grouping the one or more selected fields based on one or more of a bill-to location and a ship-to location.

14. The method of claim 9, wherein automatically populating a dynamic portion comprises automatically populating a dynamic portion of one or more of the following:
a purchase proposal;
an order agreement;
a trade-in tag; and
an order-submission cover sheet.

15. The method of claim 9, wherein providing the document to a user comprises one or more of:
printing the document;
faxing the document to the user; and
emailing the document to the user.

16. The method of claim 9, wherein providing the document to a user comprises:
providing the user with a hyperlink to the document.

17. The method of claim 9, further comprising automatically sending the document to a document repository.

18. A method of generating a contract, the method comprising:
presenting a user with an input form;
receiving, via the input form, information relevant to a transaction;
generating a worksheet comprising a plurality of transaction fields and data corresponding to one or more of the transaction fields;
selecting, from the worksheet, at least one transaction field, wherein each selected transaction field corresponds to received information having a non-null value;
identifying one or more relevant terms and conditions provisions for the transaction based on the information; and
generating a contract having at least one selected transaction field and the one or more identified terms and conditions provisions.

19. The method of claim 18, wherein generating a contract comprises:
arranging the one or more selected transaction fields into a sequence.
